(19) United States
(12) Patent Application Publication
(10) Pub. No.: US 2015/0169698 A1
(43) Pub. Date: Jun. 18, 2015

(54) METHOD AND APPARATUS OF DETERMINING TIME FOR SENDING INFORMATION

(71) Applicant: Alibaba Group Holding Limited, Grand Cayman (KY)

(72) Inventors: Liang Jia, Hangzhou (CN); Jiancheng Qi, Hangzhou (CN)

(21) Appl. No.: 14/568,658

(22) Filed: Dec. 12, 2014

(30) Foreign Application Priority Data
Dec. 13, 2013 (CN) 201310680950.9

(51) Int. Cl. G06F 17/30; H04L 12/58

(52) U.S. Cl. CPC G06F 17/30551; H04L 51/34

(57) ABSTRACT

Methods and apparatuses of determining a time for sending information, wherein a method includes obtaining n1 time periods during which an information receiving party most often opens information based on a result of statistics collected in advance for information related behavior of the information receiving party; and determining an information sending time for the information receiving party using the n1 time periods. The methods of present disclosure can predict a proper sending time for an information receiving party according to information related behavior of the information receiving party, which improves the probability that the information receiving party opens the information, and thereby promotes the effect of effectively reading the information.

### CROSS REFERENCE TO RELATED PATENT APPLICATION

This application claims foreign priority to Chinese Patent Application No. 201310680950.9 filed on Dec. 13, 2013, entitled “Method and Apparatus of Determining Time for Sending Information”, which is hereby incorporated by reference in its entirety.

### TECHNICAL FIELD

The present disclosure relates to the field of Internet application technologies, and in particular, to methods and apparatuses of determining a time for sending information.

### BACKGROUND

With the rapid popularization and development of the Internet, electronic mailing has become an important means of communication among people. The following approaches primarily exist when sending an electronic mail (email):

A first approach: a time for sending an email is randomized, and this approach is commonly used in email group sending systems.

A second approach: the time for sending the email is determined by system initialization, and the time associated with such initialization may be determined according to a subscription time or other static attributes of a user; and this approach is commonly used in subscription systems.

A third approach: the time for sending the email is determined by an operation personnel, for example, the operation personnel sets a time for sending an email as eight o'clock, and all emails are sequentially sent starting from eight o'clock accordingly; this approach is commonly used in email operation systems.

However, the above approaches of determining a time for sending an email are inflexible, and cannot send emails flexibly according to behavior of a user, which results in the emails not being able to be read efficiently. As a simple example, a user who works from nine to five is more likely to open an email received at nine o'clock in the morning than an email received at midnight. The purpose of sending an email is to transfer information in the email to a user. If the user ignores the received email, a result desired by an associated email sender cannot be achieved.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

In view of this, the present disclosure provides a method and an apparatus of determining an information sending time, so as to efficiently improve a reading effect of information.

Specific technical solutions are as follows:

The present disclosure provides a method of determining a time for sending information, the method including:

A1: obtaining n1 time periods during which an information receiving party most often opens information based on a result of statistics collected in advance for information related behavior of the information receiving party; and

B1: determining an information sending time for the information receiving party using the n1 time periods.

According to an exemplary implementation of the present disclosure, prior to A1, the method further includes:

determining whether the information related behavior of the information receiving party is sufficient for obtaining the n1 time periods during which the information receiving party most often opens the information; if affirmative, performing A1; or determining whether the information receiving party has opened any information, and if affirmative, performing A1.

According to an exemplary implementation of the present disclosure, a process of collecting the statistics in advance for the information related behavior of the information receiving party includes:

traversing a historical record of the information receiving party within a first defined time duration;

counting respective numbers of times of information receiving and opening by the information receiving party in each time period;

determining an information opening rate of the information receiving party in each time period using a ratio between the respective numbers of times of information opening and receiving; and

setting n1 time periods having first highest information opening rates as the n1 time periods during which the information receiving party most often opens information.

According to an exemplary implementation of the present disclosure, B1 specifically includes:

selecting a time period from the n1 time periods as the information sending time for the information receiving party.

According to an exemplary implementation of the present disclosure, the method further includes: marking as invalid a latest time period of a second defined time duration during which the information receiving party does not open the information in advance.

B1 specifically includes:

B11: determining, for the information receiving party, whether the n1 time periods include a time period that is not marked as invalid, and if affirmative, performing B12; and

B12: selecting a time period from time periods that are not marked as invalid in the n1 time periods as the information sending time.

According to an exemplary implementation of the present disclosure, the method further includes: marking as invalid a time period of the first defined time duration during which the information receiving party does not open the information and a number of times that the information is received exceeds a preset number of times in advance;

if a determining result of B11 is negative, performing B13; and

B13: determining whether time periods that are other than the n1 time periods and are not marked as invalid exist, and if affirmative, selecting a time period of the time periods that are not marked as invalid as the information sending time for the information receiving party; otherwise, selecting a time period from all time periods as the information sending time for the information receiving party.

The present disclosure further provides a method of determining a time for sending information, the method including:

A2: obtaining n2 time periods during which users in a region where an information receiving party is located open information most often based on a result of statistics collected in advance about information related behavior of the users in the region where the information receiving party is located; and

B2: determining an information sending time for the information receiving party using the n2 time periods.

According to an exemplary implementation of the present disclosure, the method further includes: determining whether the information related behavior of the information receiving party is sufficient for obtaining the n1 time periods during which the information receiving party most often opens information, and if not, performing A2; otherwise, determining whether the information receiving party has opened any information, and if not, performing A2.

According to an exemplary implementation of the present disclosure, a process of collecting the statistics in advance about the information related behavior of the users in the region where the information receiving party is located includes:

traversing a historical record associated with the users in the region where the information receiving party is located within a third set duration;

counting respective numbers of times of information opening and receiving by the users in the region where the information receiving party is located in each time period;

determining an information opening rate of the users in the region where the information receiving party is located in each time period using a ratio between the respective numbers of times of information opening and receiving; and

setting n2 time periods having first highest information opening rates as the n2 time periods during which the users in the region where the information receiving party is located most often open information.

According to an exemplary implementation of the present disclosure, B2 specifically includes:

selecting a time period from the n2 time periods as the information sending time for the information receiving party.

According to an exemplary implementation of the present disclosure, the method further includes: marking as invalid a latest time period of a fourth defined time duration during which the information receiving party does not open the information in advance.

B2 specifically includes:

B21: determining, for the information receiving party, whether a time period that is not marked as invalid exists in the n2 time periods, and if affirmative, performing B22; and

B22: selecting a time period from time periods that are not marked as invalid in the n2 time periods as the information sending time.

According to an exemplary implementation of the present disclosure, the method further includes: marking as invalid a time period of the third defined time duration during which the information receiving party does not open the information and a number of times that the information is received exceeds a preset number of times in advance;

if a determining result of B21 is negative, performing B23; and

B23: determining whether time periods, other than the n2 time periods, that are not marked as invalid exist, and if affirmative, selecting a time period from the time periods that are not marked as invalid as the information sending time for the information receiving party; otherwise, selecting a time period from all time periods as the information sending time for the information receiving party.

The present disclosure further provides an apparatus of determining a time for sending information, where the apparatus including:

a first time period acquisition unit, used for obtaining n1 time periods during which an information receiving party most often opens information based on a result of statistics collected in advance about information related behavior of the information receiving party; and

a sending time determination unit, used for determining an information sending time for the information receiving party using the n1 time periods.

According to an exemplary implementation of the present disclosure, the apparatus further includes: a user identification unit, used for determining whether the information related behavior of the information receiving party is sufficient for obtaining the n1 time periods during which the information receiving party most often opens the information, and if affirmative, triggering the first time period acquisition unit to perform an operation; or determining whether the information receiving party has opened any information, and if affirmative, triggering the first time period acquisition unit to perform the operation.

According to an exemplary implementation of the present disclosure, the apparatus further includes: a first behavioral statistics collection unit used for collecting the statistics about the information related behavior of the information receiving party, specifically performing:

traversing a historical record of the information receiving party within a first defined time duration;

counting respective numbers of times of information receiving and opening by the information receiving party in each time period;

determining an information opening rate of the information receiving party in each time period using a ratio between the respective numbers of times of information opening and receiving; and

setting n1 time periods having first highest information opening rates as the n1 time periods during which the information receiving party most often opens information.

According to an exemplary implementation of the present disclosure, the sending time determination unit is specifically used for selecting a time period from the n1 time periods as the information sending time for the information receiving party.

According to an exemplary implementation of the present disclosure, the apparatus further includes: a time period marking unit used for marking as invalid a latest time period of a second defined time duration during which the information receiving party does not open the information in advance; and

the sending time determination unit specifically includes:

a first determination subunit used for determining, for the information receiving party, whether the n1 time periods include a time period that is not marked as invalid; and

a time period selection subunit used for selecting a time period from time periods that are not marked as invalid in the n1 time periods as the information sending time when a determining result of the first determination subunit is positive.

According to an exemplary implementation of the present disclosure, the time period marking unit is further used for marking as invalid a time period of the first defined time duration during which the information receiving party does not open the information and a number of times that the information is received exceeds a preset number of times in advance; and

the sending time determination unit further includes:

a second determination subunit used for determining whether time periods that are other than the n1 time periods and are not marked as invalid exist when the determining result of the first determination subunit is negative; and

the time period selection subunit is further used for selecting a time period of the time periods that are not marked as invalid as the information sending time for the information receiving party when a determining result of the second determination subunit is positive; or selecting a time period from all time periods as the information sending time for the information receiving party when the determining result of the second determination subunit is negative.

The present disclosure further provides an apparatus of determining a time for sending information, the apparatus including:

a second time period acquisition unit used for obtaining n2 time periods during which users in a region where an information receiving party is located open information most often based on a result of statistics collected in advance about information related behavior of the users in the region where the information receiving party is located; and

a sending time determination unit used for determining an information sending time for the information receiving party using the n2 time periods.

According to an exemplary implementation of the present disclosure, the apparatus further includes: a user identification unit used for determining whether the information related behavior of the information receiving party is sufficient for obtaining the n1 time periods during which the information receiving party most often opens information, and if not, triggering the second time period acquisition unit to perform an operation; or determining whether the information receiving party has opened any information, and if not, triggering the second time period acquisition unit to perform the operation.

According to an exemplary implementation of the present disclosure, the apparatus further includes: a second behavioral statistics collection unit used for collecting the statistics about the information related behavior of the users in the region where the information receiving party is located, specifically performing:

traversing a historical record associated with the users in the region where the information receiving party is located within a third set duration;

counting respective numbers of times of information opening and receiving by the users in the region where the information receiving party is located in each time period;

determining an information opening rate of the users in the region where the information receiving party is located in each time period using a ratio between the respective numbers of times of information opening and receiving; and

setting n2 time periods having first highest information opening rates as the n2 time periods during which the users in the region where the information receiving party is located most often open information.

According to an exemplary implementation of the present disclosure, the sending time determination unit is specifically used for selecting a time period from the n2 time periods as the information sending time for the information receiving party.

According to an exemplary implementation of the present disclosure, the apparatus further includes: a time period marking unit used for marking as invalid a latest time period of a fourth defined time duration during which the information receiving party does not open the information in advance; and

the sending time determination unit specifically includes:

a first determination subunit used for determining, for the information receiving party, whether a time period that is not marked as invalid exists in the n2 time periods; and

a time period selection subunit used for selecting a time period from time periods that are not marked as invalid in the n2 time periods as the information sending time when a determining result of the first determination subunit is positive.

According to an exemplary implementation of the present disclosure, the time period marking unit is further used for marking as invalid a time period of the third defined time duration during which the information receiving party does not open the information and a number of times that the information is received exceeds a preset number of times in advance;

the sending time determination unit further includes:

a second determination subunit used for determining whether time periods, other than the n2 time periods, that are not marked as invalid exist when the determining result of the first determination subunit is negative; and

the time period selection subunit is further used for selecting a time period from the time periods that are not marked as invalid as the information sending time for the information receiving party when a determining result of the second determination subunit is positive; or selecting a time period from all time periods as the information sending time for the information receiving party when the determining result of the second determination subunit is negative.

As can be seen from the above technical solutions, the present disclosure predicts a proper sending time for an information receiving party based on information related behavior of the information receiving party, thus improving the probability of opening information by the information receiving party and improving an effective reading effect of the information.

### BRIEF DESCRIPTION OF THE DRAWINGS

FIG. 1 is a flow chart illustrating a method of determining an email sending time for an existing user according to a first embodiment of the present disclosure.

FIG. 2 is a flow chart illustrating a method of collecting statistics about an email opening time of an email receiving party according to the first embodiment of the present disclosure.

FIG. 3 is a flow chart illustrating a method of determining an email sending time for a new user according to a second embodiment of the present disclosure.

FIG. 4 is a flow chart illustrating a method of collecting statistics about an email opening time of users in a region according to the second embodiment of the present disclosure.

FIG. 5 is a structural diagram illustrating an apparatus of determining an email sending time according to a third embodiment of the present disclosure.

FIG. 6 is a structural diagram illustrating an apparatus of determining an email sending time according to a fourth embodiment of the present disclosure.

FIG. 7 is a structural diagram illustrating the apparatus described in FIGS. 5 and 6 in further details.

### DETAILED DESCRIPTION

To make objectives, technical solutions, and advantages of the present disclosure clearer, the present disclosure is described in detail with reference to accompanying drawings and specific embodiments.

The idea of the present disclosure is to consider a behavioral factor of an information receiving party when determining a time for sending information, predict a time period during which the information receiving party most often opens the information, and send information to the information receiving party in the time period during which the information receiving party most often opens the information.

In addition, when determining respective times for sending the information, information receiving parties are differentiated from one another, i.e., different policies of determining information sending times for a new user and an existing user are adopted: for an existing user, information related behavior of the existing user has already existed and is sufficient for obtaining information about a time period during which the existing user most often opens information, which is used as a basis for determining a time for sending information sending time; for a new user, no information related behavior of the new user exists or information related behavior is insufficient for obtaining information about a time period during which the new user most often opens information, and therefore information about a time period during which users in a region where the new user is located most often open information may be obtained and is used as a basis for determining a time for sending information.

When differentiating the information receiving parties, if information about a time period during which an information receiving party most often opens information most frequently has been determined in advance, this information receiving party is determined to be a new user. Otherwise, the information receiving party is determined to be an existing user. Other approaches may be used for differentiation. For example, an information receiving party who has opened information is determined as an existing user, and an information receiving party who has not opened any information is determined as a new user.

The method of determining a time for sending information in the present disclosure may be applicable to various types of information, for example, sending of emails, subscription-type information (such as subscribed news, advertisement), etc. In the following embodiments of the present disclosure, an example associated with emails is used. However, it should be noted that the present disclosure is not limited to email type information. Methods of determining respective times for sending emails for an existing user and a new user are described in detail hereinafter through first and the second embodiments respectively.

### First Embodiment

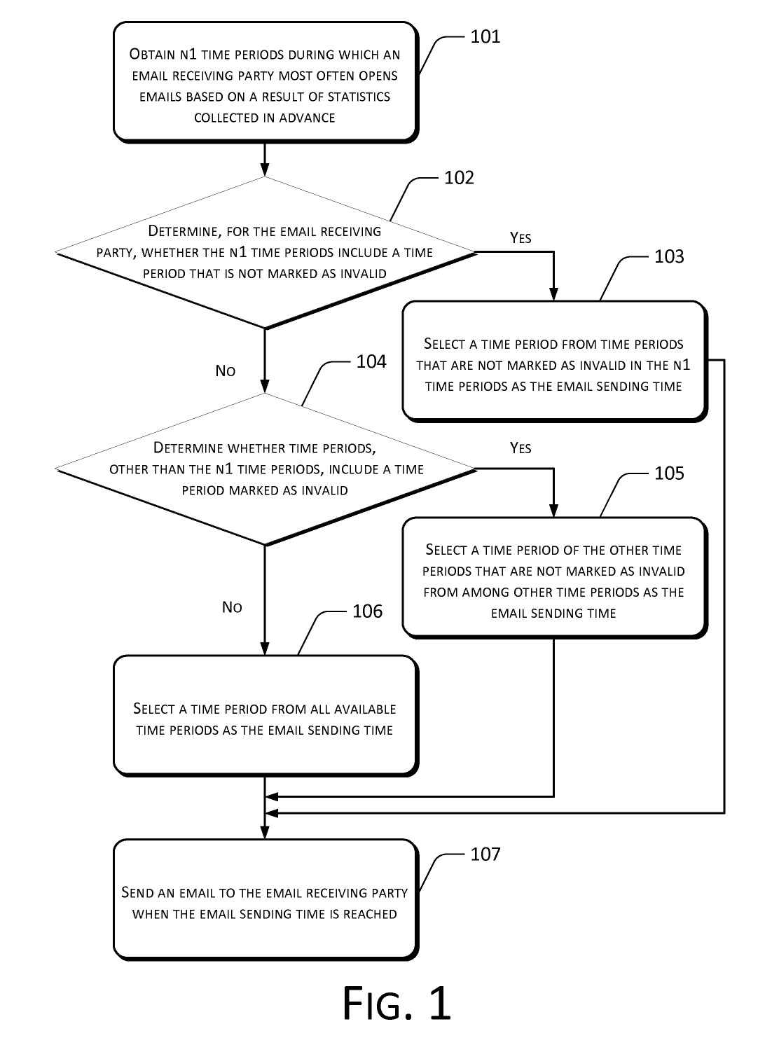

FIG. 1 is a flow chart illustrating a method of determining a time for sending an email for an existing user according to the first embodiment of the present disclosure. As shown in FIG. 1, the method may include the following blocks:

Block 101: obtain n1 time periods during which an email receiving party most often opens emails based on a result of statistics collected in advance.

Because the email receiving party is an existing user, a historical record of the email receiving party exists. By collecting statistics of times when the email receiving party opens emails based on the historical record, n1 time periods during which the email receiving party most often opens emails can be obtained. The n1 time periods are recorded. When determining a time for sending an email to the email receiving party, the n1 time periods during which the email receiving party most often opens emails can be directly obtained from the record, where n1 is a positive integer smaller than a total number of time periods. For example, n1 is set to three, and a granularity of time periods may be set according to actual needs.

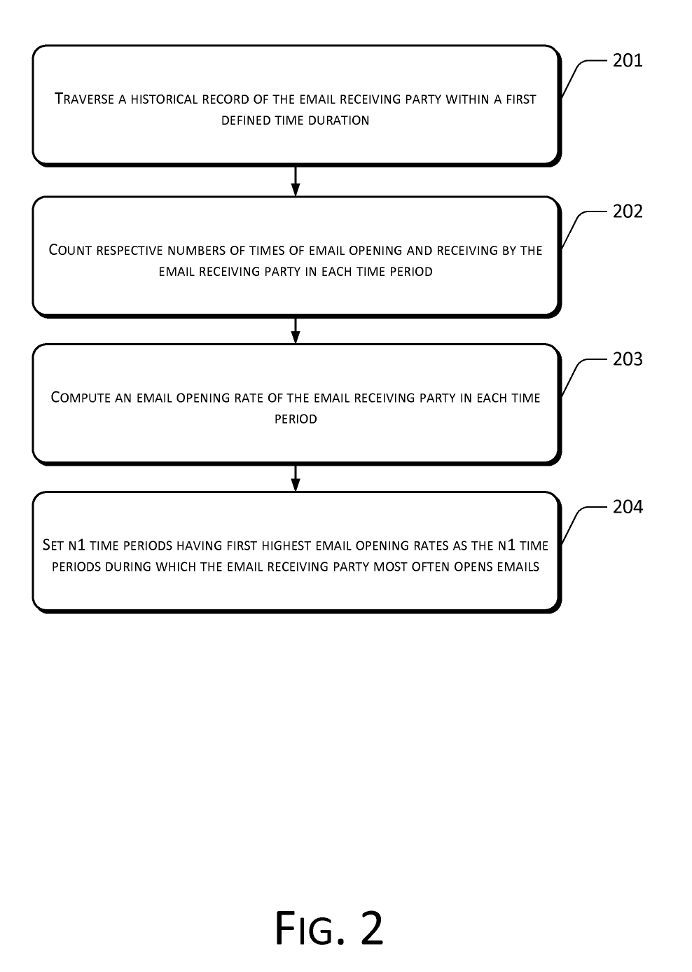

A possible process of collecting the statistics of the times when the email receiving party opens emails based on the historical record is shown in FIG. 2, which includes the following blocks:

Block 201 traverses a historical record of the email receiving party within a first defined time duration.

This process of statistics collection may be performed periodically. As such, the obtained n1 time periods during which the email receiving party most often opens emails can be updated. The first defined time duration in this block may be one year, one month, etc., which can be set according to actual needs. The historical record records information about email related behavior of the email receiving party, which includes, but is not limited to, times of opening emails.

It should be briefly explained herein that, when an email receiving party opens an email, a server may be notified that the email is opened through a feedback mechanism, and the server may record a time when the email receiving party opens that email. The present disclosure has no limitation on specific implementations of the feedback mechanism.

Block 202 counts respective numbers of times of email opening and receiving by the email receiving party in each time period.

The number of times of email receiving herein refers to a number of emails received by the email receiving party in each time period, where the emails received by the email receiving party include emails that are opened and emails that are not opened.

Block 203 computes an email opening rate of the email receiving party in each time period.

When computing an email opening rate in each time period, a ratio between a number of times of email opening and a number of times of email receiving in a certain time period may be used to calculate an email opening rate of that time period. Specifically, the ratio between the number of times of email opening and the number of times of email receiving may be directly used as the email opening rate. Alternatively, the ratio between the number of times of email opening and the number of times of email receiving may be used as the email opening rate after being processed in a certain manner. For example, the ratio between the number of times of email opening and the number of times of email receiving may be used as the email opening rate after taking the logarithm thereof.

Block 204 sets n1 time periods having first highest email opening rates as the n1 time periods during which the email receiving party most often opens emails.

Referring back to FIG. 1.

Block 102 determines, for the email receiving party, whether the n1 time periods include a time period that is not marked as invalid, and if positive, block 103 is performed; otherwise, block 104 is performed.

In this embodiment of the present disclosure, marking is further performed for each time period associated with the email receiving party, and a latest time period of a second defined time duration during which the email receiving party does not open any email is marked as invalid, where the second defined time duration is shorter than the first defined time duration. Generally, the second defined time duration may be set as a small value according to actual needs, and is used to represent a user's recent habit related to processing emails. For example, the second defined time duration may be set as one week or three days. In other words, all time durations, within a recent time period, during which the user does not open any email are marked as invalid.

Further, a time period of the first defined time duration, during which the email receiving party does not open any email and a number of times that emails are received exceeds a preset number of times, may be marked as invalid. In this case, although there is indication that emails are sent to the email receiving party in this time period, the email receiving party is basically unable to open the email in this time period, and therefore, this time period is also marked as invalid.

Block 103 selects a time period from time periods that are not marked as invalid in the n1 time periods as the email sending time, and block 107 is performed.

In this block, a time period may be selected as the email sending time according to a descending order of email opening rates of the time periods that are not marked as invalid. Alternatively, a time period may be selected as the email sending time according to a time sequence. In an embodiment, a time period may be randomly selected as the email sending time, etc.

Block 104 determines whether time periods, other than the n1 time periods, include a time period marked as invalid, and if so, block 105 is performed; otherwise, block 106 is performed.

If all the n1 time periods are marked as invalid, this indicates that an email opening habit of the user has changed. In this case, the email sending time is selected from remaining time periods.

Block 105 selects a time period of the other time periods that are not marked as invalid from among other time periods as the email sending time, and block 107 is performed.

Similarly, in this block, a time period may be selected as the email sending time according to a descending order of email opening rates of the time periods that are not marked as invalid. Alternatively, a time period may be selected as the email sending time according to a time sequence. In an implementation, a time period may be randomly selected as the email sending time.

Block 106 selects a time period from all available time periods as the email sending time, and block 107 is performed.

Block 107 sends an email to the email receiving party when the email sending time is reached.

Because the email sending time is information indicating a time period, any time point or a preset time point may be selected from that time period as a specific time point for sending the email.

After the email is sent to the email receiving party, the behavior of the email receiving party is recorded subsequently, including a time at which the user opens the email, a time at which the email is received (the time at which the email is received may be considered as the email sending time, and the time used for transmitting the email between networks is ignored), etc. The record of the behavior may be used for determining and updating the n1 time periods during which the email receiving party most often opens emails, and for marking whether a time period is invalid.

The foregoing process demonstrated by the first embodiment is an exemplary implementation. In some implementations, other approaches may also be used. For example, a simple approach, which skips the determination of whether each time period is invalid and directly selects one of the obtained n1 time periods as the email sending time for the email receiving party, may be used. For another example, after performing the determination in block 102, if the determining result thereof is negative, the method may also skip the determination in block 104, and directly select one of the time periods other than the n1 time periods as the email sending time for the email receiving party.

### Second Embodiment

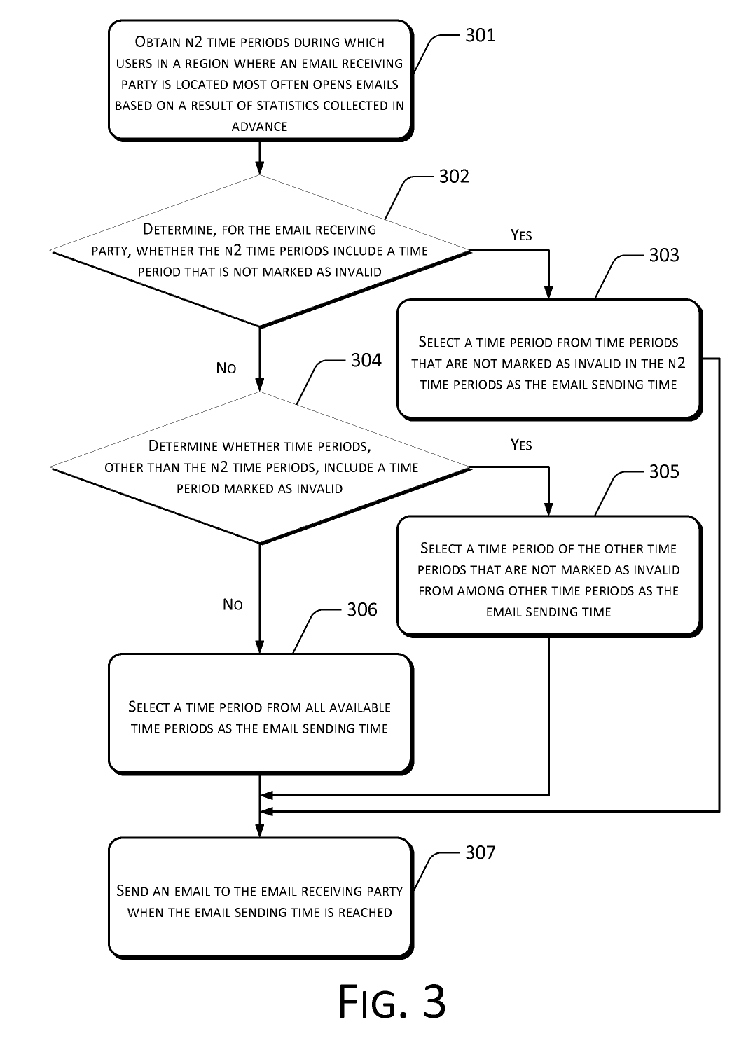

FIG. 3 is a flow chart illustrating a method of determining a time for sending an email for a new user according to the second embodiment of the present disclosure. As shown in FIG. 3, the method may include the following block:

Block 301 obtains n2 time periods during which users in a region where an email receiving party is located most often open emails based on a result of statistics collected in advance.

Because the email receiving party is a new user, no historical record associated with the email receiving party exists, or the historical record is insufficient for obtaining information about time periods during which the user most often opens emails. In this case, statistics about email opening times of all users in a region where the email receiving party is located may be collected in order to obtain n2 time periods during which the users in this region most often open emails. The n2 time periods are recorded. When determining an email sending time for the email receiving party, the n2 time periods during which the users in the region where the email receiving party is located most often open emails can be directly obtained from the record, where n2 is a positive integer smaller than a total number of time periods. For example, n2 is set to three, and s granularity of time periods may be set according to actual needs.

When determining the region where the email receiving party is located, determination may be made based on a login IP of the email receiving party or static attribute information of the email receiving party (such as address information provided by the user during registration).

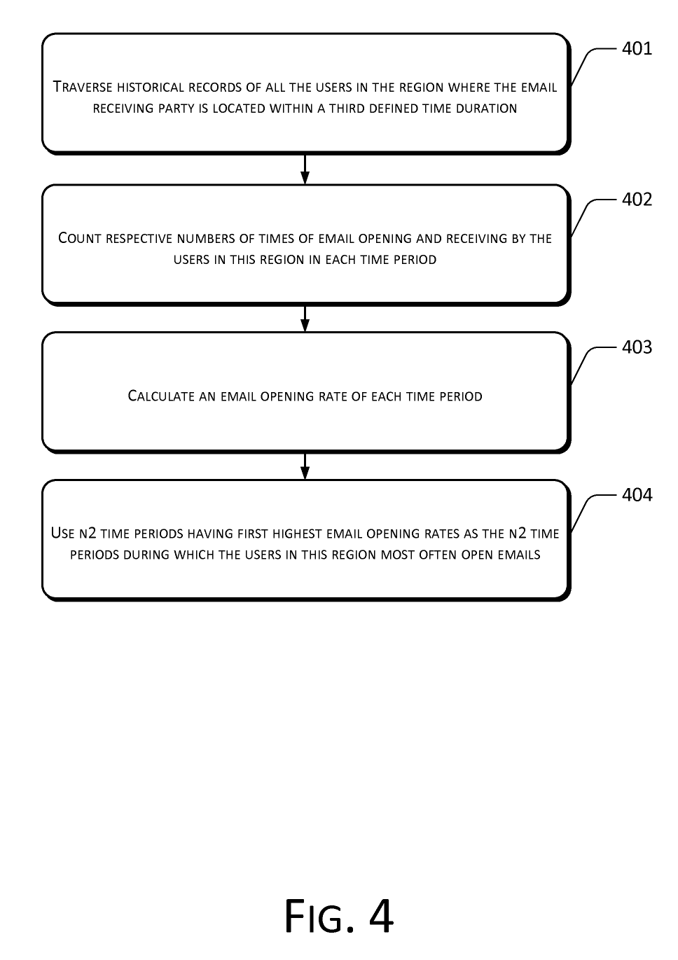

A possible process of collecting the statistics about the email opening time of all the users in the region where the email receiving party is located is shown in FIG. 4, which includes the following blocks:

Block 401 traverses historical records of all the users in the region where the email receiving party is located within a third defined time duration.

Similarly, this process of statistics collection may be performed periodically. As such, the obtained n2 time periods during which the users in the region most often open emails can be updated. The third defined time duration in this block may be one year, one month, etc., which can be set according to actual needs. The historical records record information about email related behaviors of all the users in the region, which include, but are not limited to, respective times of opening emails.

The granularity of the region involved in the embodiment of the present disclosure may be selected according to actual needs. For example, a country, a province, or a city, etc., may be adopted.

Block 402 counts respective numbers of times of email opening and receiving by the users in this region in each time period.

Numbers of times that all the users in this region open emails are totaled in each time period, and numbers of times that the emails are received is also totaled.

Block 403 calculates an email opening rate of each time period.

Block 404 uses n2 time periods having first highest email opening rates as the n2 time periods during which the users in this region most often open emails.

Referring back to FIG. 3.

Block 302 determines, for the email receiving party, whether the n1 time periods include a time period that is not marked as invalid, and if positive, block 303 is performed; otherwise, block 304 is performed.

For the email receiving party, each time period is associated with a mark. For a new user, a method of marking is the same as the method of marking described in block 102 of the first embodiment. A latest time period of a fourth defined time duration during which no email is opened is marked as invalid, where the fourth defined time duration is shorter than the third defined time duration. Generally, the fourth defined time duration may be set as a small value according to actual needs, and is used to represent a user's recent habit related to processing emails. For example, the fourth defined time duration may be set as one week or three days. In other words, all time durations, within a recent time period, during which a user does not open any email are marked as invalid.

Further, a time period of the third defined time duration, during which no email is opened and a number of times that emails are received exceeds a preset number of times, may be marked as invalid. In this case, although there is indication that emails are sent to the email receiving party in this time period, the email receiving party is basically unable to open the email in this time period, and therefore, this time period is also marked as invalid.

Block 303 selects a time period from the time periods that are not marked as invalid within the n2 time periods as the email sending time, and block 307 is performed.

In this block, a time period may be selected as the email sending time according to a descending order of email opening rates of the time periods that are not marked as invalid. Alternatively, a time period may be selected as the email sending time according to a time sequence. In some implementations, a time period may be randomly selected as the email sending time, etc.

Block 304 determines whether time periods, other than the n1 time periods, include a time period marked as invalid, and if so, block 305 is performed; otherwise, block 306 is performed.

Block 305 selects a time period of the other time periods that are not marked as invalid from among other time periods as the email sending time, and block 307 is performed.

Similarly, in this block, a time period may be selected as the email sending time according to a descending order of email opening rates of the time periods that are not marked as invalid. Alternatively, a time period may be selected as the email sending time according to a time sequence. In one implementation, a time period may be randomly selected as the email sending time.

Block 306 selects a time period from all available time periods as the email sending time, and block 307 is performed.

Block 307 sends an email to the email receiving party when the email sending time is reached.

Because the email sending time is information indicating a time period, any time point or a preset time point may be selected from that time period as a specific time point for sending the email.

After the email is sent to the email receiving party, the behavior of the email receiving party is recorded subsequently, including a time at which the user opens the email, a time at which the email is received (the time at which the email is received may be considered as the email sending time, and the time used for transmitting the email between networks is ignored), etc. When the behavior of the email receiving party meets a condition for an existing user, the method as shown in the first embodiment is used for sending emails to the email receiving party.

The foregoing process demonstrated by the second embodiment is an exemplary implementation. In some implementations, other approaches may also be used. For example, a simple approach, which skips the determination of whether each time period is invalid and directly selects one of the obtained n1 time periods as the email sending time for the email receiving party, may be used. For another example, after performing the determination in block 302, if the determining result thereof is negative, the method may also skip the determination in block 304, and directly select one of the time periods other than the n1 time periods as the email sending time for the email receiving party.

The methods provided by the present disclosure are described in detail above. An apparatus of determining a time for sending an email to an existing user and an apparatus of determining a time for sending an email to a new user are described hereinafter through the third and fourth embodiments.

### Third Embodiment

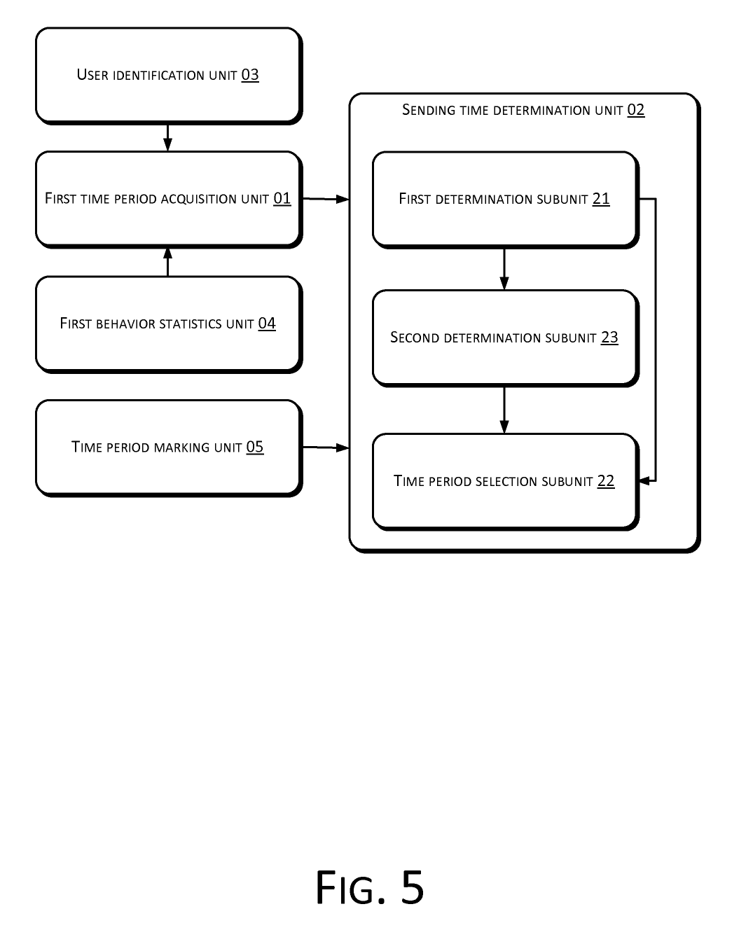

FIG. 5 is a structural diagram of an apparatus of determining a time for sending an email according to the third embodiment of the present disclosure. The apparatus may be disposed on a server side, and is used to complete the process as shown in the first embodiment. As shown in FIG. 5, the apparatus mainly includes: a first time period acquisition unit 01 and a sending time determination unit 02, and may further include a user identification unit 03, a first behavioral statistics collection unit 04 and a time period marking unit 05.

The first time period acquisition unit 01 obtains n1 time periods during which an email receiving party most often opens information based on a result of statistics collected in advance about email related behavior of the email receiving party, where n1 is a positive integer smaller than a total number of time periods. The sending time determination unit 02 determines an email sending time for the email receiving party using the n1 time periods during which the email receiving party most often opens emails.

Because the approach adopted by this apparatus is intended for an existing user, the user identification unit 03 may first determine whether the user is an existing user, i.e., determine whether the email related behavior of the email receiving party is sufficient for obtaining the n1 time periods during which the email receiving party most often opens emails, and if so, trigger the first time period acquisition unit 01 to perform an operation; or determine whether the email receiving party has opened any email, and if so, trigger the first time period acquisition unit 01 to perform the operation.

The server side stores historical records of email related behavior of each email receiving party. Based on the historical records, the first behavioral statistics collection unit 04 collects the statistics about the email related behavior of the email receiving party, wherein the statistics may be collected periodically, and in this manner, the obtained n1 time periods during which the email receiving party most often opens emails can be updated. Specifically, the following operations S11 to S14 (not shown) are performed:

Operation S11 traverses a historical record of the email receiving party within a first defined time duration. The first defined time duration may be one year, one month, or the like, and can be set according to actual needs.

Operation S12 counts respective numbers of times of email opening and receiving by the email receiving party in each time period. The number of times of email receiving herein refers to the number of emails that are received by the email receiving party in each time period, where the emails that are received by the email receiving party include emails that are opened and emails that are not opened.

Operation S13 determines an email opening rate of the email receiving party in each time period using a ratio between the number of times of email opening and the number of times of email receiving. When computing an email opening rate in each time period, a ratio between a number of times of email opening and a number of times of email receiving in a certain time period may be used to calculate an email opening rate of that time period. Specifically, the ratio between the number of times of email opening and the number of times of email receiving may be directly used as the email opening rate. Alternatively, the ratio between the number of times of email opening and the number of times of email receiving may be used as the email opening rate after being processed in a certain manner. For example, the ratio between the number of times of email opening and the number of times of email receiving may be used as the email opening rate after taking the logarithm thereof.

Operation S14 uses n1 time periods having first highest email opening rates as the n1 time periods during which the email receiving party most often opens emails.

When determining the n1 time periods during which the email receiving party most often opens emails, the sending time determination unit 02 may use a simple approach, i.e., select one of the n1 time periods as the email sending time for the email receiving party. During selection, the sending time determination unit 02 may select a time period having the highest email opening rate from among the n1 time periods, and may also select a time period according to an order of respective times or select a time period randomly.

However, the following exemplary determination approach may be used:

The time period marking unit 05 marks a latest time period of a second defined time duration during which the email receiving party does not open any email as invalid, wherein the second defined time duration is shorter than the first defined time duration, and may further mark a time period of the first defined time duration during which the email receiving party does not open any email and a number of times of email receiving exceeds a preset number of times as invalid.

In this case, the sending time determination unit 02 may specifically include: a first determination subunit 21 and a time period selection subunit 22, and may further include a second determination subunit 23.

The first determination subunit 21 determines, for the email receiving party, whether the n1 time periods include any time period that is not marked as invalid. When a determining result of the first determination subunit 21 is positive, the time period selection subunit 22 selects a time period from time periods that are not marked as invalid within the n1 time periods as the email sending time.

When the determining result of the first determination subunit 21 is negative, the second determination subunit 23 determines whether any time period that is not among the n1 time periods is not marked as invalid. When a determining result of the second determination subunit 23 is positive, the time period selection subunit 22 selects a time period from other time periods that are not marked as invalid as the email sending time for the email receiving party; or if the determining result of the second determination subunit 23 is negative, the time period selection subunit 22 selects a time period from all available time periods as the email sending time for the email receiving party.

When selecting one time period from multiple time periods to be the email sending time for the email receiving party, the time period selection subunit 22 may select a time period having the highest email opening rate, select a time period according to an order of respective times, or select a time period randomly.

### Fourth Embodiment

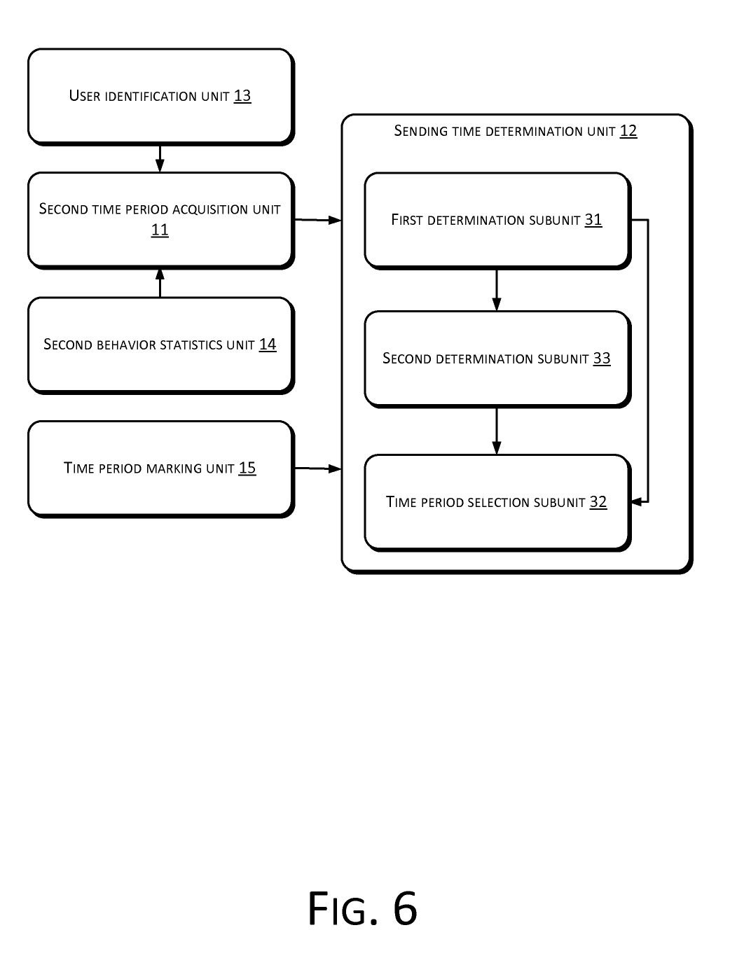

FIG. 6 is a structural diagram illustrating an apparatus of determining a time for sending an email according to the fourth embodiment of the present disclosure. The apparatus is disposed on a server side, and is used to complete the process as shown in the second embodiment. As shown FIG. 6, the apparatus mainly includes: a second time period acquisition unit 11 and a sending time determination unit 12, and may further include a user identification unit 13, a second behavioral statistics collection unit 14, and a time period marking unit 15.

The second time period acquisition unit 11 obtains n2 time periods during which users in a region where an email receiving party is located most often open emails based on a result of statistics collected in advance about email related behavior of the users in the region where the email receiving party is located, wherein n2 is a positive integer smaller than a total number of time periods. The sending time determination unit 12 determines an email sending time for the email receiving party using the n2 time periods during which the users in the region where the email receiving party is located most often open emails.

Because the approach adopted by this apparatus is intended for a new user, the user identification unit 13 may first determine whether an associated user is a new user, i.e., determine whether email related behavior of the email receiving party is sufficient for obtaining n1 time periods during which the email receiving party most often opens emails, where n1 is a positive integer smaller than the total number of time periods, and if not, trigger the second time period acquisition unit 11 to perform an operation; or determine whether the email receiving party has opened any email, and if not, trigger the second time period acquisition unit 11 to perform the operation.

The server side stores historical records associated with respective email related behavior of each email receiving party. Based on the historical records, the second behavioral statistics collection unit 14 collects the statistics about the email related behavior of the users in the region where the email receiving party is located. Specifically, the following operations S21 to S24 (not shown) are performed:

Operation S21 traverses historical records of the users in the region where the email receiving party is located within a third defined time duration. The third defined time duration may be one year, one month, or the like, and can be set according to actual needs.

Operation S22 counts respective numbers of times of email opening and receiving by the users in the region where the email receiving party is located in each time period. The number of times of email receiving herein refers to a respective number of emails that are received by a party who receives the emails in each time period, where the emails that are received by the party who receives the emails include emails that are opened and emails that are not opened.

Operation S23 determines an email opening rate of the users in the region where the email receiving party is located in each time period using a ratio between the number of times of email opening and the number of times of email receiving. When computing an email opening rate in each time period, a ratio between a number of times of email opening and a number of times of email receiving in a certain time period may be used to calculate an email opening rate of that time period. Specifically, the ratio between the number of times of email opening and the number of times of email receiving may be directly used as the email opening rate. Alternatively, the ratio between the number of times of email opening and the number of times of email receiving may be used as the email opening rate after being processed in a certain manner. For example, the ratio between the number of times of email opening and the number of times of email receiving may be used as the email opening rate after taking the logarithm thereof.

Operation S24 uses n2 time periods having first highest email opening rates as the n2 time periods during which the users in the region where the email receiving party is located most often open emails.

When determining the n2 time periods during which the users in the region where the email receiving party is located most often open emails, the sending time determination unit 12 may use a simple approach, i.e., select a time period from the n2 time periods as the email sending time for the email receiving party. During selection, the sending time determination unit 12 may select a time period having the highest email opening rate from among the n1 time periods, select a time period according to a time sequence, or select a time period randomly.

However, the following exemplary determination approach may be used:

The time period marking unit 15 marks a latest time period of a fourth defined time duration during which the email receiving party does not open any email as invalid, wherein the fourth defined time duration is shorter than the third defined time duration, and may further mark a time period of the third defined time duration during which the email receiving party does not open any email and a number of times of email receiving exceeds a preset number of times as invalid.

In this case, the sending time determination unit 12 may specifically include: a first determination subunit 31 and a time period selection subunit 32, and may further include a second determination subunit 33.

The first determination subunit 31 determines, for the email receiving party, whether the n2 time periods include any time period that is not marked as invalid. When a determining result of the first determination subunit 31 is positive, the time period selection subunit 32 selects a time period from time periods that are not marked as invalid from among the n2 time periods as the email sending time.

When the determining result of the first determination subunit 31 is negative, the second determination subunit 33 determines whether any time period other than the n2 time periods that is not marked as invalid exists. When a determining result of the second determination subunit 33 is positive, the time period selection subunit 32 selects a time period from other time periods that are not marked as invalid as the email sending time for the email receiving party; or if the determining result of the second determination subunit 33 is negative, the time period selection subunit 32 selects a time period from all available time periods as the email sending time for the email receiving party.

When selecting a time period from multiple time periods as the email sending time for the email receiving party, the time period selection subunit 32 may select a time period with the highest email opening rate, select a time period according to a time sequence, or select a time period randomly, etc.

The apparatus as shown in FIG. 5 of the third embodiment and the apparatus as shown in FIG. 6 of the fourth embodiment may be combined and implemented as a single apparatus. In that case, the sending time determination unit 02 and the sending time determination unit 12 may share one unit, the user identification unit 03 and the user identification unit 13 may share one unit, and the time period marking unit 05 and the time period marking unit 15 may share one unit.

As can be seen from the above description, the methods and apparatuses provided by the embodiments of the present disclosure have the following advantages:

1) The present disclosure predicts a proper sending time for an information receiving party based on information related behavior of the information receiving party, which improves the probability of information to be opened by the information receiving party, thereby improving an effective reading effect of the information.

2) The present disclosure can provide proper and reasonable mechanisms for a new user and an existing user respectively, so as to improve the probability of information to be opened by an information receiving party.

3) When a behavior habit of an information receiving party changes, the present disclosure can adjust an information sending time by marking a time period during which the user no longer opens any information as invalid.

In the embodiments provided by the present disclosure, it should be understood that the disclosed apparatuses and methods may be implemented in other manners. For example, the foregoing apparatus embodiments are merely illustrative, for example, a differentiation of the above units is merely a logical functional differentiation, and in an actual implementation, other ways of differentiation may exist.

The units described as separate components may or may not be physically separated. Components displayed as units may or may not be physical units, i.e., the components may be located at a single location, or may be distributed over multiple network units. Parts or all of the units may be selected to implement the objective of the solution of the embodiments according to actual needs.

In addition, the functional units in the embodiments of the present disclosure may be integrated in a single processing unit, or the units may exist as physically individual entities. Alternatively, two or more units may be integrated in one unit. The foregoing integrated unit may be implemented in a form of hardware, or may be implemented in the form of hardware with software functional unit(s).

The integrated unit implemented in the form of the software functional unit(s) may be stored in a computer readable storage medium. The software functional unit(s) is/are stored in a storage medium, which includes instructions for causing a computing device (which may include a personal computer, a server, a network device, or the like) or a processor to perform a portion of acts of the method as described in each embodiment of the present disclosure. The foregoing storage medium may include any medium that is capable of storing program codes, including: a USB flash disk, a mobile hard disk drive, a Read-Only Memory (ROM), a Random Access Memory (RAM), a magnetic disk, or an optical disk, etc.

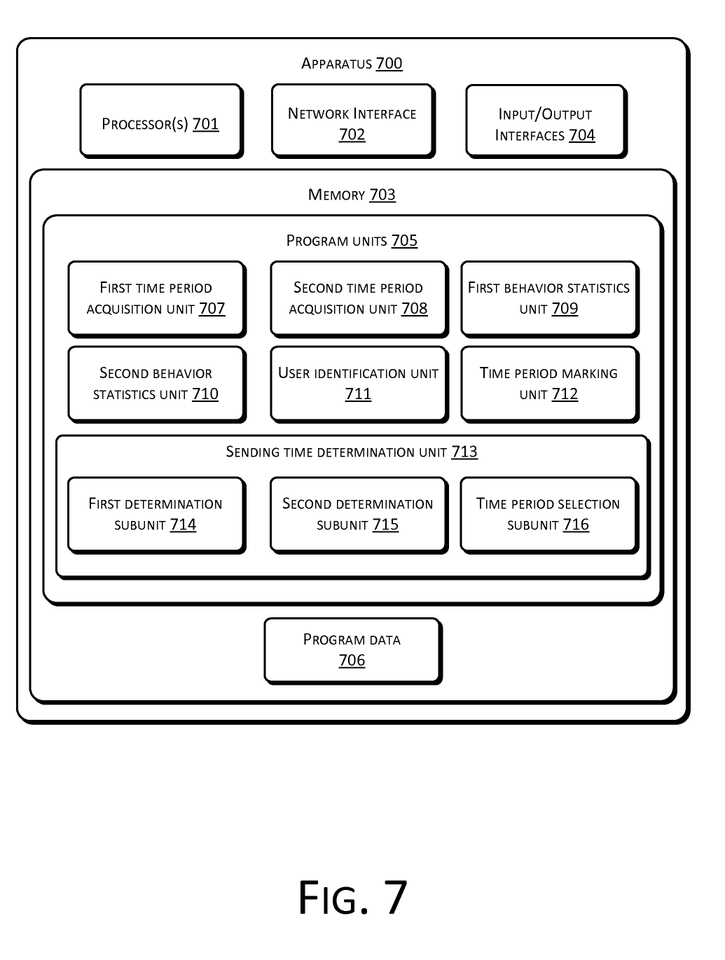

For example, FIG. 7 shows an example apparatus 700, such as the apparatus as described above, in more detail. In an embodiment, the apparatus 700 may include, but is not limited to, one or more processors 701, a network interface 702, memory 703 and an input/output interface 704.

The memory 703 may include a form of computer readable media, e.g., a non-permanent storage device, random-access memory (RAM) and/or a nonvolatile internal storage, such as read-only memory (ROM) or flash RAM. The memory 703 is an example of computer readable media.

The computer readable media may include a permanent or non-permanent type, a removable or non-removable media, which may achieve storage of information using any method or technology. The information may include a computer-readable command, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

The memory 703 may include program units 705 and program data 706. In one embodiment, the program units 705 may include a first time period acquisition unit 707, a second time period acquisition unit 708, a first behavior statistics unit 709, a second behavior statistics unit 710, a user identification unit 711, a time period marking unit 712, and/or a sending time determination unit 713. In some embodiments, the sending time determination unit 713 may include a first determination subunit 714, a second determination subunit 715 and/or a time period selection subunit 716. Details of these units and subunits may be found in the foregoing description and are therefore not redundantly described herein.

The exemplary embodiments of the present disclosure are described above, which are not intended to limit the present disclosure. Any modifications, equivalences or improvements made without departing from the spirit and the principles of the present disclosure shall fall within the protection scope of the present disclosure.

1. A method of determining a time for sending information, the method comprising:
obtaining a plurality of time periods during which an information receiving party most often opens information based on a result of statistics collected in advance for information related behavior of the information receiving party; and
determining an information sending time for the information receiving party using the plurality of time periods.

2. The method of claim 1, wherein prior to obtaining the plurality of time periods, the method further comprises:
determining whether the information related behavior of the information receiving party is sufficient for obtaining the plurality of time periods during which the information receiving party most often opens the information; if affirmative, performing the obtaining of the plurality of time periods; or
determining whether the information receiving party has opened any information, and if affirmative, performing the obtaining of the plurality of time periods.

3. The method of claim 1, wherein collecting the statistics in advance for the information related behavior of the information receiving party comprises:
traversing a historical record of the information receiving party within a first defined time duration;
counting respective numbers of times of information receiving and opening by the information receiving party in each time period;
determining an information opening rate of the information receiving party in each time period using a ratio between the respective numbers of times of information opening and receiving; and
setting multiple time periods having first highest information opening rates as the plurality of time periods during which the information receiving party most often opens information.

4. The method of claim 1, wherein determining the information sending time comprises selecting a time period from the plurality of time periods as the information sending time for the information receiving party.

5. The method of claim 1, the method further comprising marking as invalid a latest time period of a second defined time duration during which the information receiving party does not open the information in advance.

6. The method of claim 1, wherein determining the information sending time comprises:
determining, for the information receiving party, whether the plurality of time periods include a time period that is not marked as invalid; and
in response to determining that the plurality of time periods include one or more time periods that are not marked as invalid, selecting a time period from the one or more time periods that are not marked as invalid in the plurality of time periods as the information sending time.

7. The method of claim 1, the method further comprising marking as invalid a time period of the first defined time duration during which the information receiving party does not open the information and a number of times that the information is received exceeds a preset number of times in advance.

8. The method of claim 1, the method further comprising:
determining, for the information receiving party, whether the plurality of time periods include a time period that is not marked as invalid;
in response to determining that the plurality of time periods does not include any periods that are not marked as invalid, determining whether one or more time periods, that are other than the plurality of time periods and are not marked as invalid, exist;
in response to determining that the one or more time periods, that are other than the plurality of time periods and are not marked as invalid, exist, selecting a time period of the one or more time periods that are not marked as invalid as the information sending time for the information receiving party; and
in response to determining that no time period, that are other than the plurality of time periods and are not marked as invalid, exists, selecting a time period from all available time periods as the information sending time for the information receiving party.

9. One or more computer-readable media storing executable instructions that, when executed by one or more processors, cause the one or more processors to perform acts comprising:
obtaining a plurality of time periods during which users in a region where an information receiving party is located open information most often based on a result of statistics collected in advance about information related behavior of the users in the region where the information receiving party is located; and
determining an information sending time for the information receiving party using the plurality of time periods.

10. The one or more computer-readable media of claim 9, the acts further comprising:
determining whether the information related behavior of the information receiving party is sufficient for obtaining the plurality of time periods during which the information receiving party most often opens information, and if not, performing the obtaining of the plurality of time periods; or
determining whether the information receiving party has opened any information, and if not, performing the obtaining of the plurality of time periods.

11. The one or more computer-readable media of claim 9, wherein collecting the statistics in advance about the information related behavior of the users in the region where the information receiving party is located comprises:
traversing a historical record associated with the users in the region where the information receiving party is located within a third set duration;
counting respective numbers of times of information opening and receiving by the users in the region where the information receiving party is located in each time period;
determining an information opening rate of the users in the region where the information receiving party is located in each time period using a ratio between the respective numbers of times of information opening and receiving; and
setting multiple time periods having first highest information opening rates as the plurality of time periods during which the users in the region where the information receiving party is located most often open information.

12. The one or more computer-readable media of claim 9, wherein determining the information sending time comprises selecting a time period from the plurality of time periods as the information sending time for the information receiving party.

13. The one or more computer-readable media of claim 9, the acts further comprising marking as invalid a latest time period of a fourth defined time duration during which the information receiving party does not open the information in advance.

14. The one or more computer-readable media of claim 9, wherein determining the information sending time comprises:
determining, for the information receiving party, whether a time period that is not marked as invalid exists in the plurality of time periods; and
in response to determining that one or more time periods that are not marked as invalid exist in the plurality of time periods, selecting a time period from the one or more time periods that are not marked as invalid in the plurality of time periods as the information sending time.

15. The one or more computer-readable media of claim 9, the acts further comprising marking as invalid a time period of the third defined time duration during which the information receiving party does not open the information and a number of times that the information is received exceeds a preset number of times in advance.

16. The one or more computer-readable media of claim 9, wherein determining the information sending time comprises:
determining, for the information receiving party, whether a time period that is not marked as invalid exists in the plurality of time periods; and
in response to determining that no time period that is not marked as invalid exists in the plurality of time periods, determining whether one or more time periods, other than the plurality of time periods, that are not marked as invalid exist;
in response to determining that the one or more time periods, that are other than the plurality of time periods and are not marked as invalid, exist, selecting a time period of the one or more time periods that are not marked as invalid as the information sending time for the information receiving party; and
in response to determining that no time period, that are other than the plurality of time periods and are not marked as invalid, exists, selecting a time period from all available time periods as the information sending time for the information receiving party.

17. An apparatus of determining a time for sending information, the apparatus comprising:
a first time period acquisition unit, used for obtaining a plurality of time periods during which an information receiving party most often opens information based on a result of statistics collected in advance about information related behavior of the information receiving party; and
a sending time determination unit, used for determining an information sending time for the information receiving party using the plurality of time periods.

18. The apparatus of claim 17, the apparatus further comprising a user identification unit which:
determines whether the information related behavior of the information receiving party is sufficient for obtaining the plurality of time periods during which the information receiving party most often opens the information, and if affirmative, triggering the first time period acquisition unit to perform an operation; or
determines whether the information receiving party has opened any information, and if affirmative, triggering the first time period acquisition unit to perform the operation.

19. The apparatus of claim 17, the apparatus further comprising a first behavioral statistics collection unit used for collecting the statistics about the information related behavior of the information receiving party, and performing:
traversing a historical record of the information receiving party within a first defined time duration;
counting respective numbers of times of information receiving and opening by the information receiving party in each time period;
determining an information opening rate of the information receiving party in each time period using a ratio between the respective numbers of times of information opening and receiving; and
setting multiple time periods having first highest information opening rates as the plurality of time periods during which the information receiving party most often opens information.

20. The apparatus of claim 17, the apparatus further comprising a time period marking unit used for marking as invalid a latest time period of a second defined time duration during which the information receiving party does not open the information in advance, wherein the sending time determination unit comprises:
a first determination subunit used for determining, for the information receiving party, whether the plurality of time periods include a time period that is not marked as invalid; and
a time period selection subunit used for selecting a time period from time periods that are not marked as invalid in the plurality of time periods as the information sending time when a determining result of the first determination subunit is positive.
